(19) United States
(12) Patent Application Publication
(10) Pub. No.: US 2026/0052111 A1
(43) Pub. Date: Feb. 19, 2026

(54) Platform-Independent Messaging Framework

(71) Applicant: ServiceNow, Inc., Santa Clara, CA (US)

(72) Inventors: Shubham Mittal, London (GB); Kartikeya Mishra, Bengaluru (IN); Shifali Upadhyay, Telangana (IN); Shilpa Janagam, Santa Clara, CA (US)

(21) Appl. No.: 18/807,220

(22) Filed: Aug. 16, 2024

(51) Int. Cl. H04L 47/62; H04L 69/22

(52) U.S. Cl. CPC H04L 47/62; H04L 69/22

(57) ABSTRACT

An example implementation may involve: based on a message class relating to an event, writing a representation of the event to a message queue associated with the message class; reading, by a message scheduler and in accordance with a schedule, the representation of the event from the message queue; constructing a message payload, wherein the message payload includes at least part of the representation of the event and is in a unified format that supports a plurality of message structures; based on the message payload, selecting a communication endpoint for the message payload; and transmitting the message payload to the communication endpoint.

### BACKGROUND

Modern computing platforms often establish channels of communication with other computing platforms, such as cloud-based services, peer platforms, and/or third party platforms. Once established, such channels can be used to provide notifications of events and other forms of data synchronization between one or more platforms. Each of these platforms may implement different types of message bus architectures. For example, a first platform can be based on a standard messaging architecture and a second platform can be based on a proprietary messaging architecture. As a consequence, pairing these two platforms would require a custom integration between their otherwise incompatible message buses in order to communicate. Not only does this delay deployment of inter-platform communication with additional development and testing, these custom integrations often lack features while also being error prone.

### SUMMARY

Various implementations disclosed herein introduce a message bus architecture that can be used within a computing platform. Advantageously, this architecture employs flexible queuing mechanisms within the computing platform for outgoing and incoming messages. Further, the architecture allows messages to be transmitted to and received from other computing platforms at predefined endpoints (e.g., physical or logical addresses) with the messages based on a common message format. Moreover, the architecture facilitates remapping of message content classes between the computing platforms so that the internal message content classifications of the computing platforms do not need to be standardized.

As a result, computing resource utilization (e.g., processing, memory, network, and/or energy usage) is reduced. For example, by only sending messages to relevant recipient computing platforms, unnecessary message processing and transmission is reduced or eliminated on both the sending computing platform and the recipient computing platform. To that point, messages can be filtered based on content by the sending computing platform and before reaching the recipient computing platform, reducing the processing, memory, network, and/or energy usage on both computing platforms. Further, the message bus architecture allows parallel reading from and/or writing to message queues at configurable rates, thereby providing fine-grained control over processing and memory resources used to implement the message bus.

Accordingly, a first example embodiment may involve: based on a message class relating to an event, writing a representation of the event to a message queue associated with the message class; reading, by a message scheduler and in accordance with a schedule, the representation of the event from the message queue; constructing a message payload, wherein the message payload includes at least part of the representation of the event and is in a unified format that supports a plurality of message structures; based on the message payload, selecting a communication endpoint for the message payload; and transmitting the message payload to the communication endpoint.

A second example embodiment may involve a non-transitory computer-readable medium, having stored thereon program instructions that, upon execution by a computing system, cause the computing system to perform operations in accordance with any of the previous example embodiments.

In a third example embodiment, a computing system may include at least one processor, as well as memory and program instructions. The program instructions may be stored in the memory, and upon execution by the at least one processor, cause the computing system to perform operations in accordance with any of the previous example embodiments.

In a fourth example embodiment, a system may include various means for carrying out each of the operations of any of the previous example embodiments.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6A depicts outbound message processing between computing platforms, in accordance with example embodiments.

FIG. 6B depicts event topics communicated between computing platforms, in accordance with example embodiments.

FIG. 6C depicts inbound message processing between computing platforms, in accordance with example embodiments.

FIG. 7 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein. Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I. Example Technical Improvements

These embodiments provide a technical solution to a technical problem. One technical problem being solved is efficient message communication between computing platform. In practice, this is problematic because current communication platforms each operate their own message buses, and these message buses are typically not compatible with one another.

In other techniques, multiple computing platforms were required to implement a common message bus internally so that external communication using this message bus could be successful. However, these techniques do not scale up to modern systems in which it is desirable for dozens of computing platforms to be in communication with one another. Moreover, other approaches lack flexibility and reliability in terms of message queue implementation and configuration, leading to low performance and robustness. Thus, other techniques did little if anything to address facilitating inter-platform communication.

The embodiments herein overcome these limitations by introducing a message bus that is operable within a computing platform and that can deliver messages to other computing platforms by way of configurable endpoints. In this manner, inter-platform communication can be accomplished in a more reliable, performative, and robust fashion. This results in several advantages. First, by only sending messages to relevant recipient computing platforms, unnecessary message processing and transmission is reduced or eliminated on both the sending computing platform and the recipient computing platform. Second, messages can be filtered based on content by the sending computing platform and before reaching the recipient computing platform, reducing the processing, memory, network, and/or energy usage on both computing platforms. Third, the message bus architecture allows parallel reading from and/or writing to message queues at configurable rates, thereby providing fine-grained control over processing and memory resources used to implement the message bus.

Other technical improvements may also flow from these embodiments, and other technical problems may be solved. Thus, this statement of technical improvements is not limiting and instead constitutes examples of advantages that can be realized from the embodiments.

### II. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM), IT service management (ITSM), IT operations management (ITOM), and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) has been introduced to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets and/or web components for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist, including but not limited to metadata-based encodings of web components, and various uses of JAVASCRIPT® Object Notation (JSON) and/or extensible Markup Language (XML) to represent various aspects of a GUI.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### III. Example Computing Devices and Cloud-Based Computing Environments

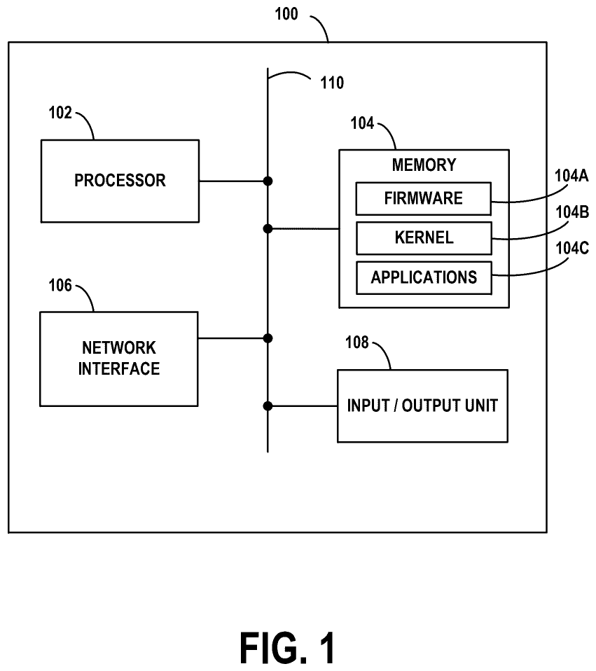

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a graphical processing unit (GPU), another form of co-processor (e.g., a mathematics or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, 10 Gigabit Ethernet, Ethernet over fiber, and so on). Network interface 106 may also support communication over one or more non-Ethernet media, such as coaxial cables or power lines, or over wide-area media, such as Synchronous Optical Networking (SONET), Data Over Cable Service Interface Specification (DOCSIS), or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed. The exact physical location, connectivity, and configuration of these computing devices may be unknown and/or unimportant to client devices. Accordingly, the computing devices may be referred to as “cloud-based” devices that may be housed at various remote data center locations.

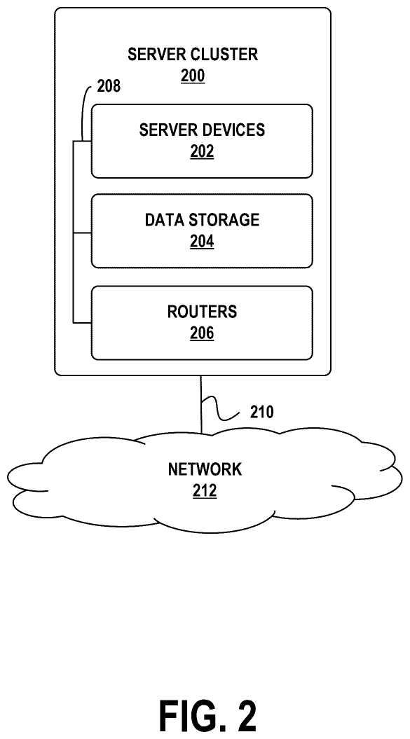

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, XML, JSON, or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### IV. Example Remote Network Management Architecture

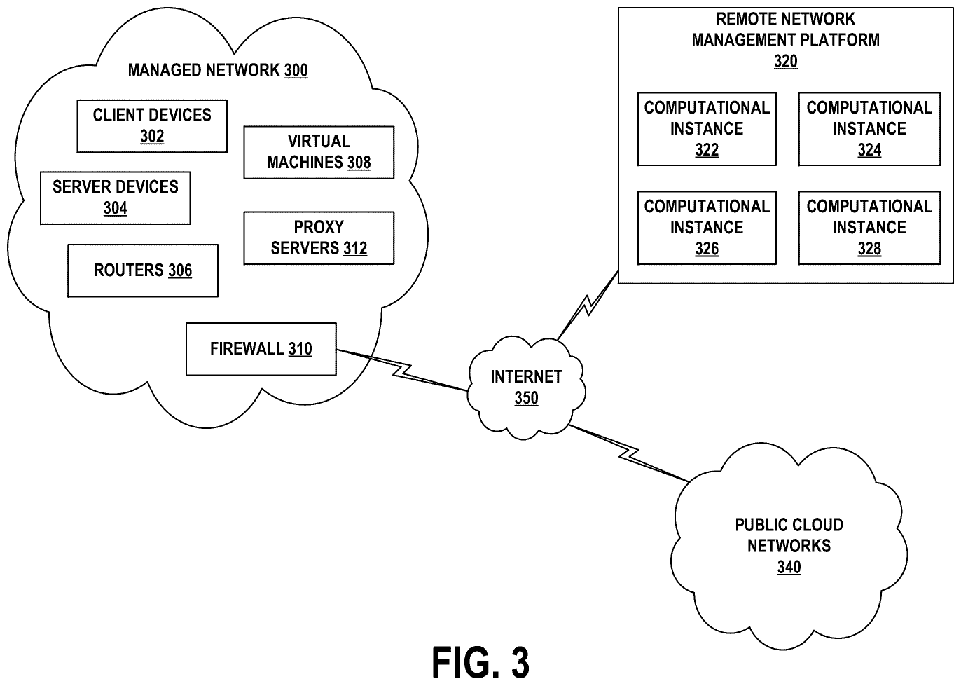

FIG. 3 depicts a remote network management architecture, in accordance with example embodiments. This architecture includes three main components—managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

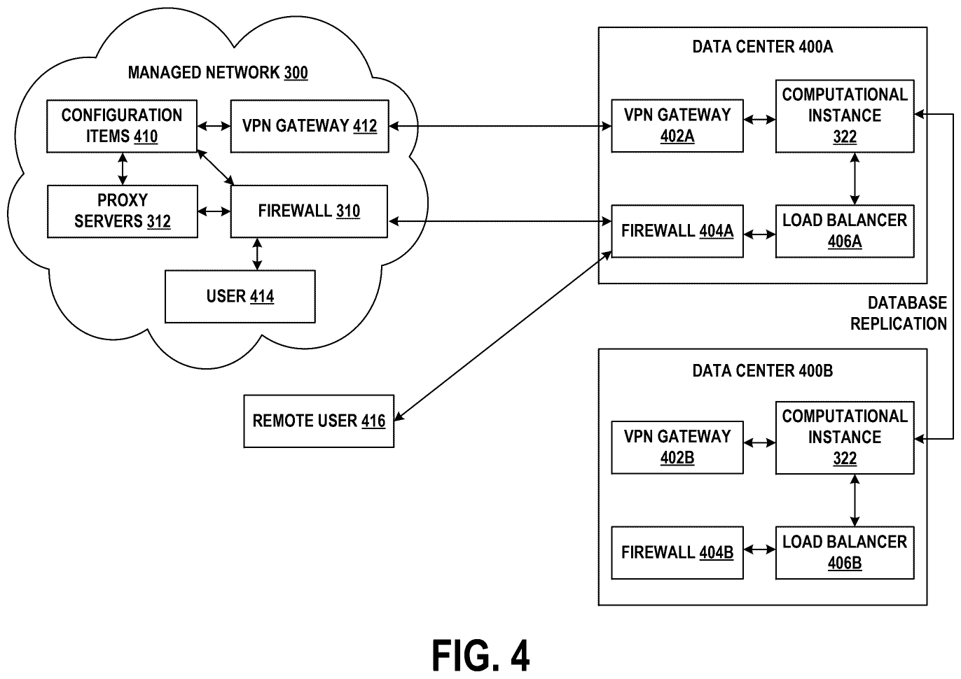

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### V. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of these devices, components, applications, and services may be referred to as configuration items.

The process of determining the configuration items and relationships therebetween within managed network 300 is referred to as discovery, and may be facilitated at least in part by proxy servers 312. To that point, proxy servers 312 may relay discovery requests and responses between managed network 300 and remote network management platform 320.

Configuration items and relationships may be stored in a CMDB and/or other locations. Further, configuration items may be of various classes that define their constituent attributes and that exhibit an inheritance structure not unlike object-oriented software modules. For instance, a configuration item class of “server” may inherit all attributes from a configuration item class of “hardware” and also include further server-specific attributes. Likewise, a configuration item class of “LINUX® server” may inherit all attributes from the configuration item class of “server” and also include further LINUX®-specific attributes. Additionally, configuration items may represent other components, such as services, data center infrastructure, software licenses, units of source code, configuration files, and documents.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

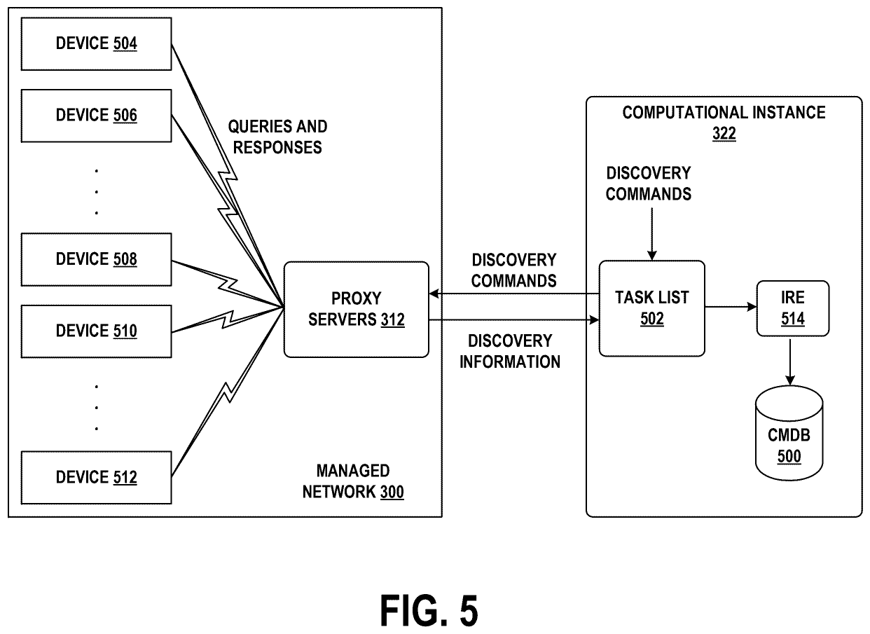

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery-horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases-under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices—for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### VI. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VII. Example Message Buses

In software systems, a message bus facilitates communication between different software applications (and thus also between the services they provide). It operates as a common layer that allows different applications to exchange messages in a scalable and flexible manner. A message bus may serve as a central conduit through which messages are transmitted, employing a publish-subscribe or a point-to-point communication model. In the publish-subscribe model, producers (publishers) send messages to the bus without requiring explicit knowledge of the consumers (subscribers). The subscribers receive messages based on their subscriptions to specific topics or channels. In the point-to-point model, messages are sent directly or indirectly (through one or more intermediate nodes) from a sender to a specific receiver.

An advantage of a message bus lies in its ability to decouple the sending and receiving components, enabling asynchronous communication. Doing so enhances system robustness and responsiveness. This allows for the integration of heterogeneous software applications and systems, and supports simplified cross-platform communication. Moreover, message buses may be designed and implemented to facilitate load balancing and fault tolerance, and can be used to implement complex routing and filtering logic so that messages are delivered to the appropriate recipients based on predefined rules.

Examples of message bus implementations include RabbitMQ, Apache Kafka, and Microsoft Azure Service Bus. Nonetheless, many software platforms have their own proprietary message buses for internal use (on the platform) and/or external use (between the platform and other platforms). With the diversity of message bus implementations, functionality, protocols, and features, it can be difficult to integrate messaging between any two software platforms. Even worse, given n software platforms that use n different message buses, providing interoperability between these software platforms would require on the order of n squared integrations between pairs of message buses. Thus, current solutions do not scale.

In the content of FIG. 3, remote network management platform 320 may employ one or more message buses for internal communication. More specifically, each of computational instances 322, 324, 326, and 328 may use a message bus for intra-instance communication (between applications operating on a single computational instance), for inter-instance communication (between applications operating on different computational instances of the same computing platform), or for inter-platform communication (between applications operating on different computing platforms). Also, managed network 300 may employ one or more message buses, again for internal or external communication. Likewise, each of public cloud networks 340 may employ one or more message buses for internal or external communication.

As noted above, remote network management platform 320 may serve more than one managed network and may communicate with more than one of public cloud networks 340. Thus, may be a need for structured communication between remote network management platform 320, managed network(s) 300, and/or public cloud networks 340. But current solutions exhibit the aforementioned scaling problem. Thus, interoperability between these systems is limited by the complexity of having to potentially carry out numerous message bus integrations.

The embodiments herein overcome these technical problems by introducing a flexible message bus architecture for remote network management platform 320. This architecture allows other platforms (e.g., managed network(s) 300 and/or public cloud networks 340) to subscribe to events generated by software applications operating on a computational instance of remote network management platform 320. The other platforms implement communication endpoints, e.g., representational states transfer (REST) or other types of endpoints, to which remote network management platform 320 can transmit representations of these events. Similar forms of communication can take place between computational instances of remote network management platform 320.

Thus, the embodiments herein define and describe a framework for communication that is independent of message bus implementation and simpler to deploy than previous message bus integrations. Nonetheless, before introducing the embodiments in detail, a brief discussion of the general types of applications that operate on remote network management platform 320 may serve to put the advantages of this framework in context.

### VIII. Example Platform Applications

As noted, remote network management platform 320 may support a number of applications and services, each of which may use or involve information from CMDB 500 and/or other databases as needed. Some of these applications and services may include task-based applications, workflows, user interface building tools, and agent interfaces, just to name a few. Other applications and services not explicitly discussed herein may benefit from the disclosed embodiments. Nonetheless, these task-based applications, workflows, user interface building tools, and agent interfaces are briefly described below to provide context for example embodiments of software that has user interfaces that could be enhanced by natural language model interactions.

### A. Task-Based Applications

Remote network management platform 320 may furnish various IT service management (ITSM) solutions including task-based applications designed to streamline and manage specific processes. Three examples are incident management, case management, and problem management.

Incident management focuses on the efficient resolution of IT service disruptions or incidents. When an issue or disruption occurs, it is logged as an incident in the incident management application. This application allows IT teams to track and manage these incidents throughout their lifecycles. It includes features such as incident creation/generation, assignment, prioritization, escalation, communication, and resolution. The incident management application provides workflows, notifications, and collaboration tools to facilitate the prompt and efficient addressing of incidents, with a goal of minimizing their impact on platform and system operations.

Case management is designed to handle diverse types of processes, requests, or workflows. It enables users to manage complex cases that require coordination across multiple groups. The case management application provides a unified platform to capture, track, and manage cases from initiation to resolution. It includes features such as case creation, classification, assignment, task tracking, collaboration, and closure. This application can be tailored to various use cases, such as HR inquiries, legal matters, facilities management, and customer support escalations among others.

Problem management is drawn to identifying and addressing the root causes of recurring incidents or issues. It helps IT teams identify underlying problems that lead to multiple incidents, analyze their impact, and initiate appropriate actions for resolution. The problem management application provides tools for problem identification, investigation, prioritization, and tracking. It allows users to link related incidents, perform root cause analysis, define workarounds or solutions, and track the progress of problem resolution. The application helps groups minimize the occurrence and impact of recurring issues, leading to improved service quality and stability for the platform and other systems.

### B. Workflows

As noted, task-based applications may employ or be integrated with workflows in some fashion. Here, a workflow defines a sequence of activities and operations used to automate and streamline processes. These workflows may include conditions and branching logic, enabling different paths within the workflow based on specific criteria, such as the values or states of variables or data.

Workflows can be integrated with other applications operable on remote network management platform 320, such as the task-based applications described above. This integration enables cross-application coordination and process synchronization. Further, remote network management platform 320 can integrate workflows with external systems and applications through web services or API calls. This allows for data exchange and collaboration with third-party tools, enabling end-to-end process automation and information sharing.

Remote network management platform 320 may include a workflow designer application that allows users to create, modify, and manage workflows using a drag-and-drop user interface. The application provides a graphical representation of the workflow, making it easier to understand and configure the ordering of activities in the workflow. The application may also provide pre-built workflow templates and libraries that offer ready-to-use workflows for common processes. These templates can be customized to meet specific needs, thus accelerating the implementation of workflows.

### C. User Interface Building Tools

Remote network management platform 320 may provide a user interface builder application that is a visual design tool for creating and customizing user interfaces within the platform. This application may employ a low-code/no-code approach to designing intuitive graphical user interfaces, enabling administrators and developers to build user interface components without extensive coding knowledge.

Notably, low-code/no-code design refers to a development approach that enables the creation of software applications with minimal or no coding required. It involves using visual interfaces, drag-and-drop components, and declarative configuration instead of writing traditional lines of code.

Low-code platforms can provide a visual development environment that allows users to design and build applications through graphical interfaces, pre-built components, and configuration options. They typically offer a set of pre-built functionalities and connectors to integrate with external systems, databases, and services. No-code platforms take the concept of low-code a step further by enabling users with little to no programming experience to create applications. These platforms offer a highly visual and intuitive interface where users can build applications using simple drag-and-drop actions, visual workflows, and configuration options. No-code platforms often provide a library of pre-built templates, modules, and integrations, allowing users to assemble and customize applications without writing any code.

Both low-code and no-code approaches aim to simplify and streamline the software development process, making it accessible to a broader range of users, including analysts, new developers, and subject matter experts. These approaches can empower non-technical users to create functional and scalable applications, reduce the reliance on traditional coding, and accelerate the development lifecycle.

To that point, the user interface builder application may include a drag-and-drop interface that simplifies the process of creating user interfaces. Users can add and arrange user interface components such as fields, buttons, containers, tables, and images onto the canvas, eliminating the need for manual coding. In doing so, the application may rely on a library of pre-built user interface components that users can choose from, including form fields, widgets, buttons, and navigation elements. These components can be added to the canvas and customized according to specific needs.

These user interface components may be bound to data sources within remote network management platform 320. This enables dynamic data display, real-time updates, and synchronization between the user interface and underlying data. The application also allows integration with other applications and workflows, as well as the use of conditional logic (e.g., visibility rules, triggering of actions, etc.) to create interactive and context-aware user interfaces.

### D. Virtual Agents

Remote network management platform 320 may also support virtual agents. These can be artificial-intelligence powered conversational interfaces designed to interact with users and provide automated assistance. Virtual agents can be integrated into various interfaces and applications, such as web portals, chat interfaces, and messaging platforms to offer self-service options and enhance the user experience. The virtual agents operable on remote network management platform 320 are different from the virtual agent features of a large language model (LLM). Notably, platform virtual agents may employ LLMs in some situations, but can also operate based on local platform content and pre-defined dialog trees, for example.

Virtual agents can engage in dynamic and context-rich conversations with users. They can guide users through predefined conversation flows, prompt for information, ask clarifying questions, and provide relevant responses or recommendations based on the user's needs. These virtual agents can be integrated with a knowledgebase, which contains a repository of articles, frequently-asked questions (FAQs), and troubleshooting information. Virtual agents can access this knowledgebase to retrieve relevant information and provide self-help resources to users. Virtual agents can also automate common tasks or processes within the platform. They can initiate workflows, create tasks, perform system actions, or provide status updates, allowing users to complete tasks without manual intervention.

Further, virtual agents can transfer conversations to live (human) agents when necessary or desirable. If a virtual agent cannot resolve a user's query or if the user requests human assistance, the conversation can be handed off to a live agent for further support and resolution. Such a handoff may involve providing, to the live agent, the context (and possibly some or all of the content) of the conversation between the user and the virtual agent.

### IX. Message Bus Architecture

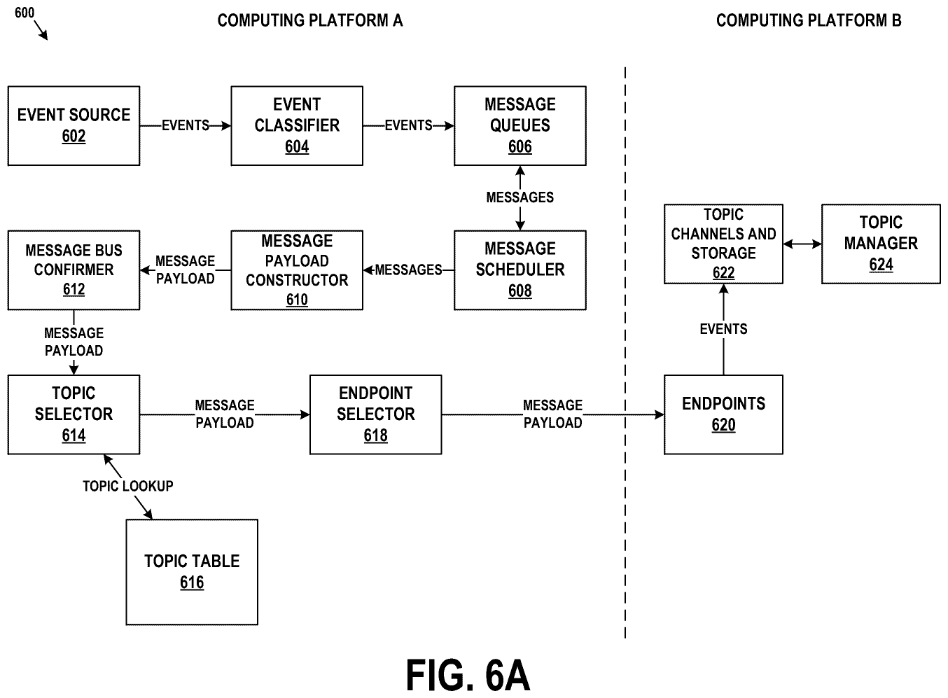

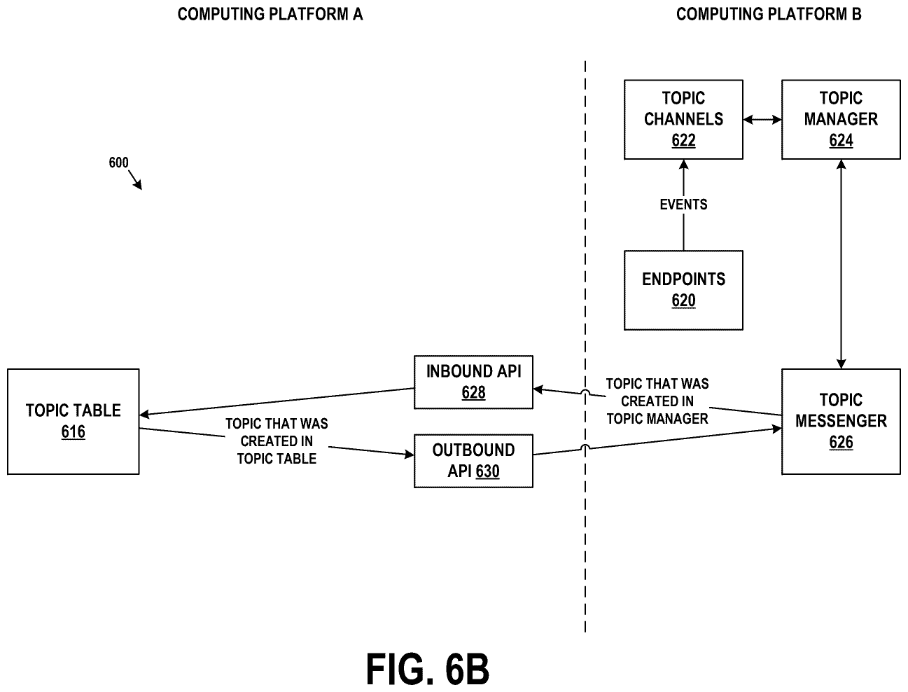

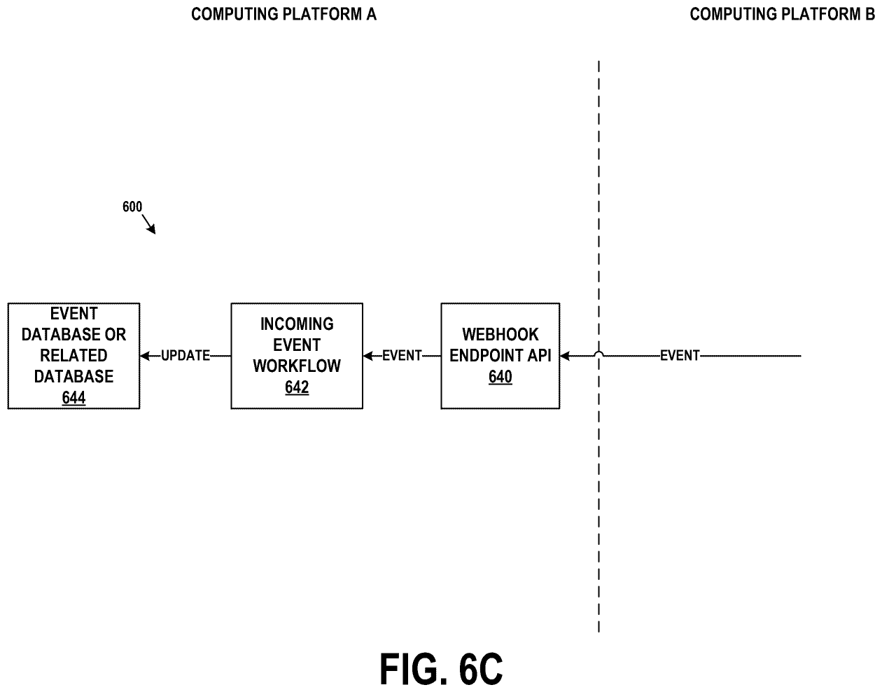

FIGS. 6A, 6B, and 6C depict an example message bus architecture 600. These figures show architecture 600 supporting a message bus for communicating event notifications between two computing platforms. However, architecture 600 can also support other types of messages. Thus, events are shown here for purposes of example.

### A. Outbound Message Processing

In the context of a computing platform (such as computing platform A), an event may be an occurrence or state change within the computing platform that may cause outbound messaging from the computing platform to other computing platforms (e.g., to computing platform B). Events can originate from various sources, including user interactions (such as mouse clicks or keyboard inputs), system operations (like file accesses, completion of processes, or changes made to a database), and hardware activities (such as processor utilization spikes or network traffic anomalies).

The generation of events can occur through multiple mechanisms depending on their nature. User-initiated events typically arise from interactions with graphical user interfaces, command-line interfaces, or other types of interfaces. System-generated events can be produced by software applications, operating systems, or hardware components when predefined conditions or thresholds are met. These conditions may include errors, warnings, status changes, timer expiries, and/or the completion of specific actions.

Once generated, events may be logged by the computing platform's event management system, which processes data relating to the event. This data may include the event type, a timestamp specifying when the event occurred, the source of the event, and any other relevant contextual information. In some of the discussion herein, events are generated by or in association with the operation of platform applications, such as task-based applications, workflows, user interface building tools, and agent interfaces. But other sources of events may exist.

The subsequent processing of events can vary. Events can trigger alerts or notifications (e.g., emails, text messages, phone calls) to inform system administrators or users about significant occurrences. An example of this may be excessive processor usage on a server prompting an alert to the IT operations team. Events can also initiate automated workflows or execute scripts in response to specific conditions. For instance, an event signaling low disk space might automatically trigger a cleanup script (to delete unneeded files) or initiate storage expansion (e.g., to acquire access to more disk space or virtual storage). Furthermore, events can create incident records within incident management systems, facilitating systematic tracking and resolution of issues (particularly useful when an event indicates an error condition). Additionally, events can provide data for analysis, enabling the identification of trends, anomaly detection, and enhancement of system performance and reliability, with historical event data aiding in predictive analytics and capacity planning.

In the example shown in FIGS. 6A and 6B, events are generated by an event source 602 on computing platform A. These events may be, for instance, a change to a database (e.g., additions, deletions, or edits to a table of the database or a row within such a table). In this example, it is assumed that the operator of computing platform B is interested in receiving indications of at least some of changes to the database. For instance, the operator of computing platform B may use a database of computing platform A for incident management workflows, but may be interested in maintaining a local copy of certain high-importance incidents from this database.

As an illustration, incidents may be assigned priorities of P1, P2, P3, and P4, with P1 incidents being higher priority than P2 incidents, P2 incidents being higher priority than P3 incidents, and P3 incidents being higher priority than P4 incidents. The operator of computing platform B may seek to be notified of P1 incidents only, and to keep local records of these P1 incidents in computing platform B so that they can be easily tracked until they are resolved. The local records of incidents may also be used to trigger workflows that are initiated by way of computing platform B.

In this illustration, event source 602 may be an incident management database (e.g., this database may contain a table in which rows respectively represent incidents). The database itself or a monitoring tool may be configured to detect when a row containing a P1 incident is added to the table, removed from the table, or updated in the table. Once such an occurrence is detected, an event representing the change may be generated.

The incident may be represented as a data structure (e.g., in JSON or XML format) that contains one or more of the following fields: incident_number (a unique identifier for the incident), short_description (a brief summary of the incident), priority (a priority level of the incident such as P1, P2, P3, or P4), state (the current state of the incident, such as new, in progress, on hold, resolved, closed), category (a classification of the incident, such as software, hardware, networking), opened_at (a timestamp indicating when the incident was opened), and/or location (a physical or logical location relevant to the incident). Notably, more or fewer fields or a different set of fields may be contained within an incident data structure.

Likewise, the event may be represented as a data structure (e.g., in JSON or XML format) that contains one or more of the following fields: event ID (a unique identifier for the event), source (the origin of the event, indicating which system or application generated it), node (the name or ID of the host or device where the event was generated), resource (the specific resource, e.g., application, service, or component, related to the event), type (a classification of the event, such as alert, informational, or warning), severity (the level of seriousness of the event, often categorized as critical, major, minor, warning, or informational, description (an explanation of the event, providing more context or information), time of event (a timestamp indicating when the event occurred), class (the category or class of the event, often used for organizing and filtering events), status (the current status of the event, such as open, in progress, or resolved), event source type (indicates the type of source, such as monitoring tool, manual entry, or automated script), priority (the importance or urgency of addressing the event, e.g., P1, P2, P3, or P4). Other fields in an event data structure may be possible.

To be clear, the incident and event data structures may be different. Event data structures are more generic, as data from various types of platform applications are mapped to into an event. In the case of mapping an incident to an event, this may occur as follows. The incident_number field of the incident is associated with the event ID field of the event, but these two values are expected to be different. The short_description field of the incident is copied (at least in part) into the description field of the event. The priority field of the incident is copied (at least in part) into the priority field of the event. The opened_at field of the incident is copied into the time of event field of the event. Other mappings may exist.

Event classifier 604 may be software that stamps each event (e.g., writes to a relevant field of the event data structure or provides associated metadata) with a class (e.g., a type). Event classifier 604 may base this classification on any field(s) in the event for that was received from the data source, such as the category or a source node of the incident, or when an incident management application provides the incident. Event classifier 604 is an optional feature that may not be in all implementations.

Message queues 606 may be one or more queues that hold events for some period of time. Message queues 606 may be thread-safe (so that multiple threads of execution can read from and/or write to each queue without causing data corruption or inconsistencies) and facilitate a first-in-first-out (FIFO) queuing discipline, for example. In some cases, each class provided by event classifier 604 may have one or more dedicated queues in message queues 606 for holding events of that class. These queues may exist in main memory, long-term (e.g., disk) storage, or some combination thereof). To be clear, there may be an n-to-1 relationship between event classes and queues, in which a single queue is dedicated to storing messages representing events of n different classes.

Message scheduler 608 may be software that reads and/or removes, at a configurable interval, a configurable number of events of a particular class from a queue in message queues 606. Message scheduler 608 may perform this task for each message queue. For example, message scheduler 608 may be configured to remove up to 5 events from a given queue each second. These events may be passed to message payload constructor 610.

Message payload constructor 610 may be software that receives sets of one or more events from message scheduler 608 and packages these events into common message payloads in the form of messages. Thus, more than one event may be placed in each message. The format of the payload may be the transaction message format (TMF), as just one example. TMF defines a header, body, and footer for messages, where the header contains metadata about the message (e.g., message type, a timestamp, sender information, intended recipient information, and/or a unique identifier), the body contains the content of the events in the form of a message, and the footer contains additional information related to the message, such as a hash or checksum of the message. Nonetheless, non-TMF formats may be employed and, regardless of format, message payload constructor 610 may provide message payloads to message bus confirmer 612. Adopting a neutral and flexible format such as TMF allows for increased compatibility between software applications and computing platforms, because such a unified format support a plurality of different message structures.

Message bus confirmer 612 may be optional software that determines whether computing platform A has an established message bus for outgoing messages of the type in the message payload. For example, message bus confirmer 612 may maintain or have access to a set of mappings between event types and message buses conformed for that event type. If message bus confirmer 612 determines that no such message bus is configured, it may raise an error and/or delete the message payload (thereby reducing computing resource utilization that would have been used for storage and transmission of the message payload). Otherwise, the message payload may be provided to topic selector 614.

Topic selector 614 may be software that determines a topic for the message payload. Topics may be the same as event types, but alternatively could be different. In some cases, multiple event types may be associated with the same topic, and/or multiple topics may be associated with the same event type. In the latter case, the topic may be selected by information in the message payload other than the event or other than just the event. In full generality, an arbitrarily complex Boolean or regular expression could be applied to determine a topic from a message payload. Alternatively, a semantic meaning of the message payload could be determined by way of natural language processing. Regardless, topic selector 614 may contain or have access to topic table 616, and may look up the topic of a message payload based on one or more fields within the message payload or other metadata associated with the message payload.

Topic table 616 may contain mappings between: (i) one or more fields of message payloads and/or metadata associated with the message payloads, and (ii) topics. The topics may be of various forms, and may include descriptors such as “newly opened P1 incidents”, “newly closed P1 incidents”, or “modified P1 incidents”, for example. Other possibilities exist, as topics may be defined in numerous ways.

Endpoint selector 618 may be software that receives message payloads for which topics are known and provides these events payload to associated endpoints 620. For example, endpoint selector 618 may maintain or have access to a set of mappings between topics and definitions of endpoints 620. Endpoint selector 618 may determine, for each incoming message payload, one or more endpoints from endpoints 620 based on these mappings, and transmit the message payload to this endpoint. If not applicable endpoint is configured, an error may be raised and/or the message payload may be deleted (thereby reducing computing resource utilization that would have been used for storage and transmission of the message payload).

Endpoints 620 may be logical or physical interfaces on another computing platform, such as computing platform B. In other embodiments, endpoints 620 may include such interfaces on the same computational instance of computing platform A as event source 602, a different computational instance of computing platform A as event source 602, or one or more external computing platforms. Just computing platform B is shown as an example, but more external computing platforms may be present each of which may contain one or more of endpoints 620. In some cases, endpoints 620 may take the form of REST servers or REST proxy servers, e.g., an intermediate endpoint that forwards messages to an actual REST server based on a uniform resource locator (URL), headers, and/or other content in the messages.

Endpoints 620 may provide events from message payloads to topic channels and storage 622. The latter include databases, files, or other repositories for events stored in a format that could be the same, similar, or dissimilar to that of computing platform A. Endpoints 620 may communicate with topic channels and storage 622 over any message bus supported by computing platform A. Notably, this need not be the same type of message bus as that of computing platform A, and thus could be any known or custom message bus. In this manner, the message buses of computing platforms A and B do not need to directly interact with one another, thereby increasing interoperability.

Topics supported by topic channels and storage 622 may be configured by way of topic manager 624 (e.g., software with a web-based interface, command line interface, and/or API for editing topic channels 622). For example, different topics may be “P1 incidents related to web databases” or “P2 incidents relating to load balancers”. Each of these topics could be stored, for example in different tables of a database.

### B. Topic Synchronization

These embodiments also facilitate two-way synchronization of topics between computing platforms A and B. For example, FIG. 6B introduces inbound API 628 and output API 630 on computing platform A. Inbound API 628 and output API 630 may be, for example, REST interfaces or some other form of interface that allows communication between the platforms.

When a change is made to topic table 616 on computing platform A, a representation of this change can be provided to outbound API 630. The change may be, for example, creation of a new topic in topic table 616 (as shown in FIG. 6B), deletion of a topic in topic table 616, or modification of a topic in topic table 616 (e.g., changing the name of topic). Outbound API 630 may provide a representation of this change to topic messenger 626 on computing platform B. Topic messenger 626 may communicate this representation to topic manager 624 via its API. Topic manager 624 may then, in turn, update topic channels 622 accordingly with the change to the topic.

When a change is made to topic channels 622 on computing platform B, a representation of this change may be provided to topic messenger 626 by way of the API of topic manager 624. The change may be, for example, creation of a new topic in topic channels 622 by topic manager 624 (as shown in FIG. 6B), deletion of a topic in topic channels 622, or modification of a topic in topic channels 622 (e.g., changing the name of topic). Inbound API 628 may provide a representation of this change to topic table 616 on computing platform A, thereby updating topic table 616 accordingly with the change to the topic.

In this fashion, the representations of topics between topic table 616 and topic channels 626 maintain synchronization.

### C. Inbound Message Processing

The embodiments herein may also support inbound message processing, particular inbound event processing. For example, FIG. 6C depicts an event being transmitted from computing platform B to computing platform A. The event may be an occurrence or state change within computing platform B that may cause outbound messaging from computing platform B to one or more other computing platforms such as computing platform A.

To receive representations of events, computing platform A may be configured with webhook endpoint API 640. Webhook endpoint API 640 may be an HTTP callback and/or executable program code linked to a software application (here, incoming event workflow 642), When an event occurs within computing platform B that is to be provided to computing platform A, computing platform B may transmit an HTTP POST request to a URL configured in the webhook. This HTTP POST request may contain a payload, typically in JSON format, with details about the event.

Webhooks can be established by specifying the URL of webhook endpoint API 640 on computing platform A to process incoming events. Computing platform B may be configured to transmit events only of specific types to webhook endpoint API 640. Security measures such as token-based authentication, request validation, and/or IP address whitelisting may be implemented to prevent unauthorized access to webhook endpoint API 640.

Reception of an event by webhook endpoint API 640 may trigger execution of incoming event workflow 642. Incoming event workflow 642 may involve one or more of the following processing steps: (i) placing the event in a message queue for subsequent processing, (ii) reading the event from the message queue, (iii) validating that the event is properly formatted, of a supported type, and otherwise capable of being understood and securely processed by computing platform A, and/or (iv) parsing the event to determine its content. If any of these operations fail, an error may be raised and/or the event may be deleted (thereby reducing computing resource utilization that would have been used for storage and transmission of the event).

The processing of incoming event workflow 642 may result in an update being made to event database or related database 644. For example, an event database on computing platform A may be updated to include the event. In this case, the addition of such a new event to the event database may further cause the triggering of one or more alarms or notifications. Alternatively or additionally, In this case, the addition of such a new event to a related database (e.g., a database for an incident management application or another platform application) may or may not result in generation of any alarms or notifications.

### X. Example Operations

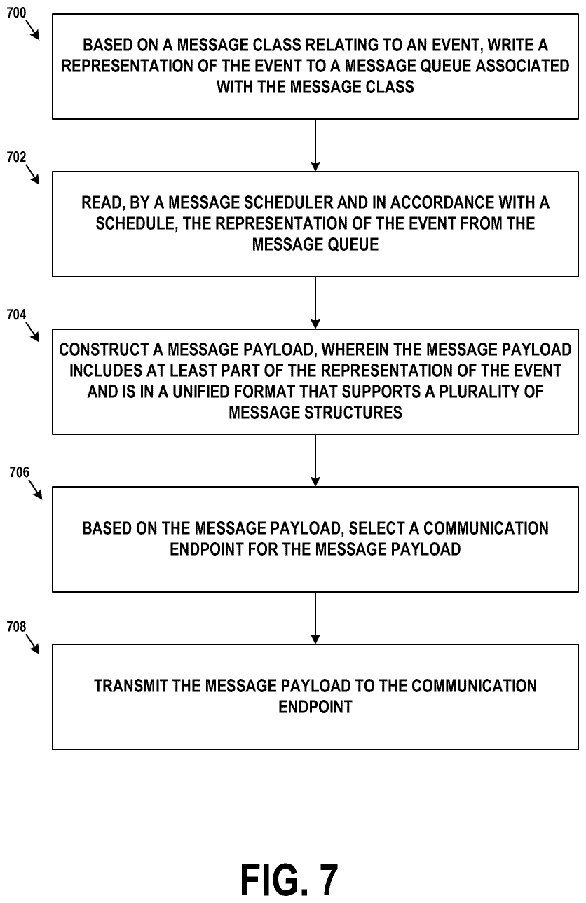

FIG. 7 is a flow chart illustrating an example embodiment. The process illustrated by FIG. 7 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 7 may be simplified by the removal of any one or more of the features shown therein. Further, these embodiments may be combined with features, aspects, and/or implementations of any of the previous figures or otherwise described herein.

Block 700 may involve, based on a message class relating to an event, writing a representation of the event to a message queue associated with the message class.

Block 702 may involve reading, by a message scheduler and in accordance with a schedule, the representation of the event from the message queue.

Block 704 may involve constructing a message payload, wherein the message payload includes at least part of the representation of the event and is in a unified format that supports a plurality of message structures.

Block 706 may involve, based on the message payload, selecting a communication endpoint for the message payload.

Block 708 may involve transmitting the message payload to the communication endpoint. The communication endpoint may be a REST server or REST proxy server, e.g., an intermediate endpoint that forwards messages to an actual REST server based on a URL, headers, and/or other content in the messages.

Some embodiments may further involve determining, by an event classifier and from a plurality of message classes, the message class relating to the event.

In some embodiments, the message queue is selected from a plurality of message queues, wherein each of the message queues is dedicated to storing messages from one or more of the message classes.

In some embodiments, the message scheduler is configured to read a predetermined number of messages from the message queue at a predetermined interval.

In some embodiments, reading the representation of the event from the message queue comprises reading a plurality of representations of events from the message queue, wherein constructing the message payload comprises placing each of the representations of events in the message payload.

Some embodiments may further involve: detecting a change to a database associated with a software application; and, in response to the change to the database, generating the event, wherein the event contains data relating to the change to the database.

In some embodiments, selecting the communication endpoint for the message payload comprises selected the communication endpoint based applying a Boolean expression or a regular expression to content within the message payload.

In some embodiments, the communication endpoint for the message payload is selected based on a table that maps content of the message payload to topics, and wherein each of the topics is associated with one or more communication endpoints.

In some embodiments, selecting the communication endpoint for the message payload comprises: performing a semantic analysis of content within the message payload to determine a semantic meaning of the content; based on the table, determining a topic associated with the semantic meaning; and selecting, based on the topic, the communication endpoint from the one or more communication endpoints.

Some embodiments may involve: determining that the table has been updated with a further association between a further topic and a further communication endpoint; and, in response to determining that the table has been updated, transmitting, by way of an outbound interface to a computing platform associated with the further communication endpoint, a representation of the further association.

In some embodiments, the further topic is a topic of the message payload or the further communication endpoint is the communication endpoint.

Some embodiments may involve: receiving, by way of an inbound interface and from a computing platform, a representation of a further association between a further topic and a further communication endpoint; and in response to representation of the further association, updating the table to include the further association.

Some embodiments may involve: based on the message payload, selecting a second communication endpoint for the message payload; and transmitting the message payload to the second communication endpoint.

In some embodiments, a message structure of the plurality of message structures is supported by a computing platform associated with the communication endpoint.

### XI. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of non-transitory computer readable medium such as a storage device including RAM, ROM, a disk drive, a solid-state drive, or another tangible storage medium.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
based on a message class relating to an event, writing a representation of the event to a message queue associated with the message class;
reading, by a message scheduler and in accordance with a schedule, the representation of the event from the message queue;
constructing a message payload, wherein the message payload includes at least part of the representation of the event and is in a unified format that supports a plurality of message structures;
based on the message payload, selecting a communication endpoint for the message payload; and
transmitting the message payload to the communication endpoint.

2. The method of claim 1, further comprising:
determining, by an event classifier and from a plurality of message classes, the message class relating to the event.

3. The method of claim 2, wherein the message queue is selected from a plurality of message queues, and wherein each of the message queues is dedicated to storing messages from one or more of the message classes.

4. The method of claim 1, wherein the message scheduler is configured to read a predetermined number of messages from the message queue at a predetermined interval.

5. The method of claim 1, wherein reading the representation of the event from the message queue comprises reading a plurality of representations of events from the message queue, and wherein constructing the message payload comprises placing each of the representations of events in the message payload.

6. The method of claim 1, further comprising:
detecting a change to a database associated with a software application; and
in response to the change to the database, generating the event, wherein the event contains data relating to the change to the database.

7. The method of claim 1, wherein selecting the communication endpoint for the message payload comprises selected the communication endpoint based applying a Boolean expression or a regular expression to content within the message payload.

8. The method of claim 1, wherein the communication endpoint for the message payload is selected based on a table that maps content of the message payload to topics, and wherein each of the topics is associated with one or more communication endpoints.

9. The method of claim 8, wherein selecting the communication endpoint for the message payload comprises:
performing a semantic analysis of content within the message payload to determine a semantic meaning of the content;
based on the table, determining a topic associated with the semantic meaning; and
selecting, based on the topic, the communication endpoint from the one or more communication endpoints.

10. The method of claim 8, further comprising:
determining that the table has been updated with a further association between a further topic and a further communication endpoint; and
in response to determining that the table has been updated, transmitting, by way of an outbound interface to a computing platform associated with the further communication endpoint, a representation of the further association.

11. The method of claim 10, wherein the further topic is a topic of the message payload or the further communication endpoint is the communication endpoint.

12. The method of claim 8, further comprising:
receiving, by way of an inbound interface and from a computing platform, a representation of a further association between a further topic and a further communication endpoint; and
in response to representation of the further association, updating the table to include the further association.

13. The method of claim 1, further comprising:
based on the message payload, selecting a second communication endpoint for the message payload; and
transmitting the message payload to the second communication endpoint.

14. The method of claim 1, wherein a message structure of the plurality of message structures is supported by a computing platform associated with the communication endpoint.

15. A non-transitory computer-readable medium, having stored thereon program instructions that, upon execution by a computing system, cause the computing system to perform operations comprising:
based on a message class relating to an event, writing a representation of the event to a message queue associated with the message class;
reading, by a message scheduler and in accordance with a schedule, the representation of the event from the message queue;
constructing a message payload, wherein the message payload includes at least part of the representation of the event and is in a unified format that supports a plurality of message structures;
based on the message payload, selecting a communication endpoint for the message payload; and
transmitting the message payload to the communication endpoint.

16. The non-transitory computer-readable medium of claim 15, wherein the operations further comprise:
detecting a change to a database associated with a software application; and
in response to the change to the database, generating the event, wherein the event contains data relating to the change to the database.

17. The non-transitory computer-readable medium of claim 15, wherein the communication endpoint for the message payload is selected based on a table that maps content of the message payload to topics, and wherein each of the topics is associated with one or more communication endpoints.

18. The non-transitory computer-readable medium of claim 17, wherein selecting the communication endpoint for the message payload comprises:
performing a semantic analysis of content within the message payload to determine a semantic meaning of the content;
based on the table, determining a topic associated with the semantic meaning; and
selecting, based on the topic, the communication endpoint from the one or more communication endpoints.

19. The non-transitory computer-readable medium of claim 15, the operations further comprising:
determining that the table has been updated with a further association between a further topic and a further communication endpoint; and
in response to determining that the table has been updated, transmitting, by way of an outbound interface to a computing platform associated with the further communication endpoint, a representation of the further association.

20. A system comprising:
one or more processors; and
memory, containing program instructions that, upon execution by the one or more processors, cause the system to perform operations comprising:
based on a message class relating to an event, writing a representation of the event to a message queue associated with the message class;
reading, by a message scheduler and in accordance with a schedule, the representation of the event from the message queue;
constructing a message payload, wherein the message payload includes at least part of the representation of the event and is in a unified format that supports a plurality of message structures;
based on the message payload, selecting a communication endpoint for the message payload; and
transmitting the message payload to the communication endpoint.
